(19) United States
(12) Patent Application Publication
(10) Pub. No.: US 2025/0316258 A1
(43) Pub. Date: Oct. 9, 2025

(54) SIGNAL PROCESSING METHOD OF PROCESSING A DIGITAL INPUT SIGNAL, AND MEASUREMENT INSTRUMENT

(71) Applicant: Rohde & Schwarz GmbH & Co. KG, Muenchen (DE)

(72) Inventors: Florian RAMIAN, Muenchen (DE); Wolfgang WENDLER, Muenchen (DE)

(21) Appl. No.: 18/628,390

(22) Filed: Apr. 5, 2024

(51) Int. Cl. G10K 11/178

(52) U.S. Cl. CPC G10K 11/17853; G10K 11/17825; G10K 2210/504

(57) ABSTRACT

A signal processing method includes: receiving, by a signal input, a digital input signal from a device under test; capturing, by a measurement circuit, at least one IQ measurement set based on the received input signal, wherein the at least one IQ measurement set comprises a plurality of IQ measurement points; determining, by an analysis circuit, a total noise of the digital input signal over frequency based on the at least one IQ measurement set; determining, by the analysis circuit, an instrument noise over frequency, wherein the instrument noise corresponds to noise generated by the measurement instrument; and determining, by the analysis circuit, a ratio of the instrument noise and the total noise over frequency, thereby obtaining a frequency-dependent scaling factor. Further, a measurement instrument is described.

### FIELD OF THE DISCLOSURE

Embodiments of the present disclosure generally relate to a signal processing method of processing a digital input signal by a measurement instrument. Embodiments of the present disclosure further relate to a measurement instrument.

### BACKGROUND

The noise figure is a measure that is of interest for characterizing the behavior of a device under test under operation, for instance a communication device such as a user end device or any other signal processing device. If noise requirements on a particular device under test are strict, i.e. the device under test may only generate small amounts of noise in order to pass a certain test, additional noise generated by the measurement equipment itself may become highly relevant.

Noise-reduction techniques are known that reduce the overall noise level of a signal chain. However, these techniques do not distinguish between different sources of the noise such that the noise generated by the device under test may inadvertently be reduced as well. Thus, the noise figure of the device under test cannot be measured precisely with these techniques.

A way to circumvent this problem is using high-quality measurement instruments having a particularly low inherent noise level. However, such measurement instruments are rather expensive.

Thus, there is a need for a signal processing method as well as a measurement instrument that allow for a cost-efficient assessment of a noise contribution of a device under test.

### SUMMARY

The following summary of the present disclosure is intended to introduce different concepts in a simplified form that are described in further detail in the detailed description provided below. This summary is neither intended to denote essential features of the present disclosure nor shall this summary be used as an aid in determining the scope of the claimed subject matter.

Embodiments of the present disclosure provide a signal processing method of processing a digital input signal by a measurement instrument. The measurement instrument comprises a signal input, a measurement circuit, and an analysis circuit. In an embodiment, the signal processing method comprises:
receiving, by the signal input, a digital input signal from a device under test;
capturing, by the measurement circuit, at least one IQ measurement set based on the received input signal, wherein the at least one IQ measurement set comprises a plurality of IQ measurement points;
determining, by the analysis circuit, a total noise of the digital input signal over frequency based on the at least one IQ measurement set;
determining, by the analysis circuit, an instrument noise over frequency, wherein the instrument noise corresponds to noise generated by the measurement instrument; and
determining, by the analysis circuit, a ratio of the instrument noise and the total noise over frequency, thereby obtaining a frequency-dependent scaling factor.

The IQ measurement points may also be called “IQ measurement samples”.

The signal processing method according to embodiments of the present disclosure is based on the idea to determine two different noise quantities over frequency, namely the total noise of the digital input signal over frequency as well as the instrument noise over frequency. Therein, the total noise over frequency comprises all types of noise irrespective of its origin, for example noise generated by the device under test and noise generated by the measurement instrument. The instrument noise over frequency may only comprise noise generated by the measurement instrument itself.

Accordingly, the determined frequency-dependent scaling factor describes the ratio of the instrument noise and the total noise in dependence of frequency, i.e. the frequency-dependent scaling factor is a measure for the proportion of the instrument noise in the total noise as a function of frequency. Thus, based on the frequency-dependent scaling factor and the determined total noise, a frequency-dependent noise contribution of the device under test can be determined.

The inventors of the present application have recognize that the frequency-dependent scaling factor allows to precisely determine a noise contribution of the device under test for different types of noise such as colored noise and/or phase noise, while a scalar scaling factor (i.e. a scaling factor that is constant over frequency) would only allow to determine a noise contribution of the device under test with the noise contribution being modeled as white Gaussian noise.

According to an aspect of the present disclosure, filter coefficients of a digital filter, for example, are determined by the analysis circuit based on the frequency-dependent scaling factor. In general, the digital filter may be used in order to correct the digital input signal and/or the total noise of the digital input signal for noise originating in the measurement instrument, i.e. for the instrument noise, as will be described in more detail below. Thus, the digital filter with filter coefficients determined based on the frequency-dependent scaling factor allows to perform precise measurements on the digital input signal corrected for the instrument noise, for example measurements with respect to noise characteristics of the device under test.

In an embodiment of the present disclosure, the frequency-dependent scaling factor is transformed into time-domain, thereby obtaining the filter coefficients. In other words, the filter coefficients of the digital filter are the Fourier transform of the frequency-dependent scaling factor. For example, a fast Fourier transform (FFT) of the frequency-dependent scaling factor may be determined by the analysis circuit, thereby obtaining the filter coefficients.

According to another aspect of the present disclosure, the total noise, for example, is filtered by the digital filter, thereby obtaining a filtered noise. The filtered noise corresponds to the total noise corrected for the instrument noise. Thus, the filtered noise only comprises noise originating outside of the measurement instrument, for example only noise generated by the device under test. Accordingly, a performance of the device under test with respect to its noise characteristics can be assessed based on the filtered noise with enhanced accuracy.

In an embodiment, noise originating in the measurement instrument, i.e. the instrument noise, is removed from the total noise on a frequency-selective basis by filtering the total noise by the digital filter. This allows for assessment of the performance of the device under test based on the filtered noise for a plurality of different noise types with enhanced accuracy, e.g. for colored noise and/or phase noise.

In an embodiment of the present disclosure, at least one performance parameter is determined based on the filtered noise, wherein the at least one performance parameter is indicative of a signal quality of the digital input signal. As already described above, the filtered noise corresponds to noise originating outside of the measurement instrument, for example in the device under test. Thus, the signal quality of the digital input signal can be assessed directly based on the filtered noise, wherein influences of the measurement instrument on the signal quality are eliminated.

Accordingly, the at least one performance parameter is indicative of a performance of the device under test. For example, the filtered noise may be forwarded to a measurement application, wherein the measurement application is configured to determine the at least one performance parameter. In an embodiment, the measurement application may be integrated into the analysis circuit. In an embodiment, the measurement application comprises executable program instructions for execution by a processor circuit, such as a microprocessor, GPU, CPU, etc.

The at least one performance parameter may comprise an error vector magnitude (EVM). However, it is to be understood that the at least one performance parameter may comprise any other suitable signal parameter that is indicative of the signal quality of the digital input signal.

An aspect of the present disclosure provides that the digital input signal, for example, is corrected based on the filtered noise, thereby obtaining a noise-corrected input signal. In an embodiment, the noise-corrected input signal may be a useful signal (also called “wanted signal”) generated by the device under test plus noise originating outside of the measurement instrument, for example the noise originating in the device under test. Accordingly, the performance of the device under test, for example with respect to its noise characteristics, can be assessed based on the noise-corrected input signal with enhanced accuracy, as the influence of the instrument noise on the measurements is eliminated.

In an embodiment, the noise-corrected input signal may be obtained by subtracting the total noise from the digital input signal, and by adding the filtered noise.

In an embodiment, the at least one performance parameter described above may be determined based on the noise-corrected input signal.

In an embodiment, the noise-corrected input signal may be forwarded to a measurement application, wherein the measurement application is configured to determine the at least one performance parameter based on the noise-corrected input signal.

Alternatively or additionally, arbitrary other types of analysis may be performed on the noise-corrected input signal by the measurement application. As the instrument noise is removed from the noise-corrected input signal, these measurements can be performed with enhanced accuracy.

In an embodiment of the present disclosure, the instrument noise is determined by connecting at least one calibration standard to the signal input. In other words, the instrument noise may be determined based on a calibration measurement performed with at least one calibration standard being connected to the signal input. For example, the at least one calibration standard may be a “matched” calibration standard, i.e. an impedance-matched load that can be connected to the signal input.

According to an aspect of the present disclosure, a plurality of measurement sets, for example, are captured by the measurement circuit based on the received input signal, wherein each IQ measurement set comprises a plurality of IQ measurement points, wherein an IQ average is determined by the analysis circuit based on the captured IQ measurement sets, thereby obtaining an averaged signal, and wherein the total noise of the digital input signal over frequency is determined based on the averaged signal and based on the plurality of IQ measurement sets.

When performing the IQ average, noise comprised in the captured IQ measurement sets cancels at least partially, for example completely. Therein, the noise cancels regardless of its origin, i.e. regardless of whether the noise originates in the device under test or in the measurement instrument. Accordingly, in the averaged signal, noise contributions from all sources are suppressed.

In an embodiment, the IQ average may be performed in frequency domain, wherein the average is performed over IQ measurement points belonging to the same frequency bin.

By subtracting the averaged signal from the individual IQ measurement sets, a plurality of noise vectors can be determined, wherein each noise vector represents the total noise in the respective IQ measurement set.

In an embodiment, the total noise described above may, for example, be obtained by averaging over the plurality of noise vectors.

Embodiments of the present disclosure further provide a signal processing method of processing a digital input signal by a measurement instrument. The measurement instrument comprises a signal input, a measurement circuit, and an analysis circuit. In an embodiment, the signal processing method comprises:
receiving, by the signal input, a digital input signal from a device under test;
capturing, by the measurement circuit, at least one IQ measurement set based on the received input signal, wherein the at least one IQ measurement set comprises a plurality of IQ measurement points;
determining, by the analysis circuit, a total noise of the digital input signal over frequency based on the at least one IQ measurement set;
determining, by the analysis circuit, an instrument noise over frequency, wherein the instrument noise corresponds to noise generated by the measurement instrument;
determining, by the analysis circuit, an instrument phase noise, wherein the instrument phase noise corresponds to phase noise generated by the measurement instrument;
adding, by the analysis circuit, the instrument phase noise to the instrument noise, thereby obtaining composite noise; and
determining, by the analysis circuit, a ratio of the composite noise and the total noise over frequency, thereby obtaining a frequency-dependent scaling factor.

Compared to the embodiments of the signal processing method described above, not only the instrument noise is taken into account for determining the frequency-dependent scaling factor, but also the instrument phase noise.

Accordingly, the determined frequency-dependent scaling factor describes the ratio of the composite noise (i.e. the sum of the instrument noise and the instrument phase noise) and the total noise in dependence of frequency, i.e. the frequency-dependent scaling factor is a measure for the proportion of the composite noise in the total noise as a function of frequency.

Thus, based on the frequency-dependent scaling factor and the determined total noise, a frequency-dependent noise contribution of the device under test can be determined while correctly taking the instrument noise and the instrument phase noise into account.

By additionally taking the instrument phase noise into account, the measurement accuracy may be further increased, for example when performing measurements near a carrier frequency of a carrier of the digital input signal.

Regarding the further advantages and properties of the signal processing method, reference is made to the explanations given with respect to the embodiments of the signal processing method described above.

In an embodiment of the present disclosure, filter coefficients of a digital filter are determined by the analysis circuit based on the frequency-dependent scaling factor. In general, the digital filter may be used in order to correct the digital input signal and/or the total noise of the digital input signal for noise and phase noise originating in the measurement instrument, i.e. for the instrument noise and the instrument phase noise, as will be described in more detail below. Thus, the digital filter with filter coefficients determined based on the frequency-dependent scaling factor allows to perform precise measurements on the digital input signal corrected for the instrument noise and for the instrument phase noise, for example measurements with respect to noise characteristics of the device under test.

According to an aspect of the present disclosure, the frequency-dependent scaling factor, for example, is transformed into time-domain, thereby obtaining the filter coefficients. In other words, the filter coefficients of the digital filter are the Fourier transform of the frequency-dependent scaling factor. For example, a fast Fourier transform (FFT) of the frequency-dependent scaling factor may be determined by the analysis circuit, thereby obtaining the filter coefficients.

In an embodiment, the total noise may be filtered by the digital filter, thereby obtaining a filtered noise. The filtered noise corresponds to the total noise corrected for the instrument noise and for the instrument phase noise. Thus, the filtered noise only comprises noise originating outside of the measurement instrument, for example only noise generated by the device under test. Accordingly, a performance of the device under test with respect to its noise characteristics can be assessed based on the filtered noise with enhanced accuracy.

In an embodiment, noise originating in the measurement instrument, i.e. the instrument noise, is removed from the total noise on a frequency-selective basis by filtering the total noise by the digital filter. Further, the total noise is corrected for phase noise originating in the measurement instrument. This allows for assessment of the performance of the device under test for a plurality of different noise types with enhanced accuracy, e.g. for colored noise and/or phase noise.

Another aspect of the present disclosure provides that at least one performance parameter, for example, is determined based on the filtered noise, wherein the at least one performance parameter is indicative of a signal quality of the digital input signal. As already described above, the filtered noise corresponds to noise originating outside of the measurement instrument, for example in the device under test. Thus, the signal quality of the digital input signal can be assessed directly based on the filtered noise, wherein influences of the measurement instrument on the signal quality are eliminated.

For example, the filtered noise may be forwarded to a measurement application, wherein the measurement application is configured to determine the at least one performance parameter.

In an embodiment of the present disclosure, the at least one performance parameter comprises an error vector magnitude (EVM). However, it is to be understood that the at least one performance parameter may comprise any other suitable signal parameter that is indicative of the signal quality of the digital input signal.

In an embodiment of the present disclosure, the digital input signal is corrected based on the filtered noise, thereby obtaining a noise-corrected input signal. In an embodiment, the noise-corrected input signal may be a useful signal (also called “wanted signal”) generated by the device under test plus noise originating outside of the measurement instrument, for example the noise originating in the device under test, wherein the noise-corrected input signal is also corrected for the instrument phase noise. Accordingly, the performance of the device under test, for example with respect to its noise characteristics, can be assessed based on the noise-corrected input signal with enhanced accuracy.

In an embodiment, the noise-corrected input signal may be obtained by subtracting the total noise from the digital input signal, and by adding the filtered noise.

In an embodiment, the at least one performance parameter described above may be determined based on the noise-corrected input signal.

In an embodiment, the noise-corrected input signal may be forwarded to a measurement application, wherein the measurement application is configured to determine the at least one performance parameter based on the noise-corrected input signal.

Alternatively or additionally, arbitrary other types of analysis may be performed on the noise-corrected input signal by the measurement application. As the instrument noise and the instrument phase noise are removed from the noise-corrected input signal, these measurements can be performed with enhanced precision.

According to an aspect of the present disclosure, the instrument phase noise, for example, is determined by connecting a known phase noise source to the signal input. In other words, the instrument phase noise may be determined based on a calibration measurement performed with the known phase noise source being connected to the signal input.

In an embodiment, the instrument phase noise may be estimated based on a phase noise model, wherein the phase noise model describes the phase noise generated by the measurement instrument. In other words, the instrument phase noise may be calculated or estimated based on a mathematical substitute model of the measurement instrument, namely based on the phase noise model.

According to another aspect of the present disclosure, a plurality of measurement sets, for example, are captured by the measurement circuit based on the received input signal, wherein each IQ measurement set comprises a plurality of IQ measurement points, wherein an IQ average is determined by the analysis circuit based on the captured IQ measurement sets, thereby obtaining an averaged signal, and wherein the total noise of the digital input signal over frequency is determined based on the averaged signal and based on the plurality of IQ measurement sets.

When performing the IQ average, noise comprised in the captured IQ measurement sets cancels at least partially, for example completely. Therein, the noise cancels regardless of its origin, i.e. regardless of whether the noise originates in the device under test or in the measurement instrument. Accordingly, in the averaged signal, noise contributions from all sources are suppressed.

In an embodiment, the IQ average may be performed in frequency domain, wherein the average is performed over IQ measurement points belonging to the same frequency bin.

By subtracting the averaged signal from the individual IQ measurement sets, a plurality of noise vectors can be determined, wherein each noise vector represents the total noise in the respective IQ measurement set.

The total noise described above may be, for example, obtained by averaging over the plurality of noise vectors.

Embodiments of the present disclosure further provide a measurement instrument. In an embodiment, the measurement instrument comprises a signal input, a measurement circuit, and an analysis circuit. The signal input is configured to receive a digital input signal from a device under test. The measurement circuit is configured to capture at least one IQ measurement set based on the received input signal, wherein the at least one IQ measurement set comprises a plurality of IQ measurement points. The analysis circuit is configured to determine a total noise of the digital input signal based on the at least one IQ measurement set. The analysis circuit further is configured to determine an instrument noise over frequency or a composite noise, wherein the instrument noise corresponds to noise generated by the measurement instrument, and wherein the composite noise is a sum of the instrument noise and instrument phase noise. The analysis circuit is configured to determine a ratio of the instrument noise and the total noise over frequency or a ratio of the composite noise and the total noise over frequency, thereby obtaining a frequency-dependent scaling factor.

In an embodiment, the measurement instrument may be configured to perform the signal processing method according to any one (or all) of the embodiments describe above.

Regarding the further advantages and properties of the measurement instrument, reference is made to the explanations given above with respect to the signal processing method, which also hold for the measurement instrument and vice versa.

### DESCRIPTION OF THE DRAWINGS

The foregoing aspects and many of the attendant advantages of the claimed subject matter will become more readily appreciated as the same become better understood by reference to the following detailed description, when taken in conjunction with the accompanying drawings, wherein:

FIG. 1 schematically shows an example of a signal processing system with a measurement instrument according to an embodiment of the present disclosure;

FIG. 2 schematically shows another example of a signal processing system with a measurement instrument according to an embodiment of the present disclosure;

FIG. 3 shows a representative flow chart of a signal processing method according to an embodiment of the present disclosure;

FIG. 4 schematically shows the signal processing system of FIG. 1 with a calibration standard or known phase noise source connected to the measurement instrument; and

FIG. 5 shows another example flow chart of a signal processing method according to an embodiment of the present disclosure.

### DETAILED DESCRIPTION

The detailed description set forth below in connection with the appended drawings, where like numerals reference like elements, is intended as a description of various embodiments of the disclosed subject matter and is not intended to represent the only embodiments. Each embodiment described in this disclosure is provided merely as an example or illustration and should not be construed as preferred or advantageous over other embodiments. The illustrative examples provided herein are not intended to be exhaustive or to limit the claimed subject matter to the precise forms disclosed.

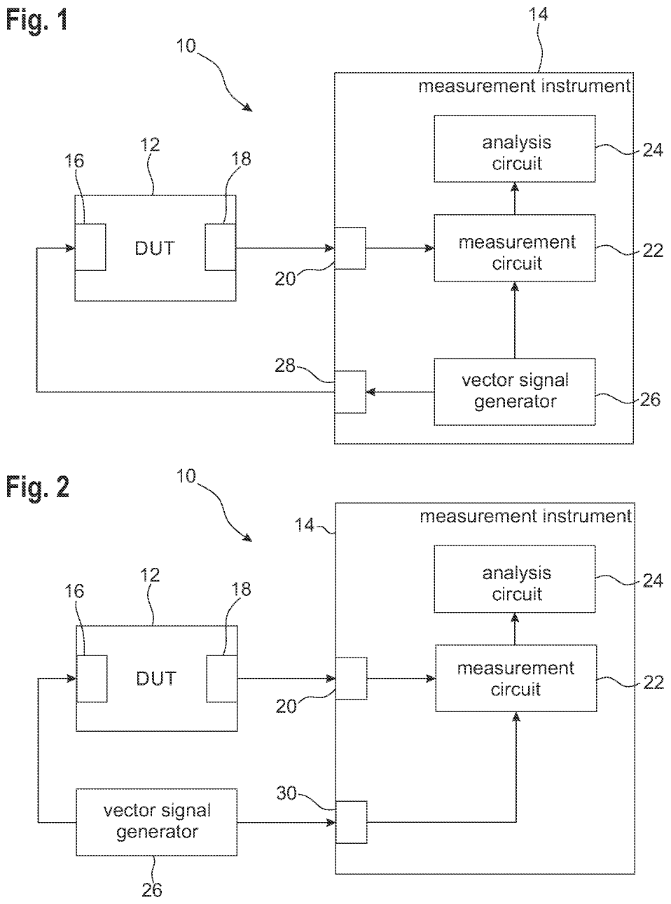

FIG. 1 schematically shows a measurement system 10 comprising a device under test 12 and a measurement instrument 14 in accordance with an embodiment of the present application. The device under test 12 may be established as any electronic device that is configured to generate an electronic signal. In an embodiment, the device under test 12 may be an electronic component that is used in Wi-Fi applications or in 5G applications.

In the example shown in FIG. 1, the device under test 12 is established as a two-port device having an input port 16 and an output port 18. For example, the device under test 12 may be established as an amplifier that is configured to amplify an input signal received via the input port 16, and to output a corresponding amplified signal via the output port 18. As another example, the device under test 12 may be established as a filter that is configured to filter an input signal received via the input port 16 in a predefined manner, and to output a corresponding filtered signal via the output port 18.

However, the device under test 12 may also be established as a one-port device having only a single port, or as a multi-port device having more than two ports, e.g. three, four or more ports. Without restriction of generality, the device under test 12 is assumed to be a two-port device as illustrated in FIGS. 1 and 2 in the following.

In an embodiment, the measurement instrument 14 is established as any type of suitable measurement instrument that is configured to perform the functionalities described below. For example, the measurement instrument 14 may be established as an oscilloscope, for example as a digital oscilloscope, as a signal analyzer, as a vector signal analyzer, as a spectrum analyzer, or as a vector network analyzer.

In the embodiment illustrated in FIG. 1, the measurement instrument 14 comprises a signal input 20, a measurement circuit 22, an analysis circuit 24, a vector signal generator 26, and a signal output 28. The vector signal generator 26 is configured to generate a test signal that is forwarded to the input port 16 of the device under test 12 via the signal output 28 of the measurement instrument 14.

In general, the test signal is a digital signal having defined arbitrary properties. The exact properties of the test signal depend on the device under test 12 and on the type of measurements that are to be conducted on the device under test 12. The device under test 12 processes the test signal and generates a digital input signal based on the test signal.

The signal input 20 of the measurement instrument 14 is connected, for example directly connected with the output port 18 of the device under test 12 in a signal transmitting manner. For example, the signal input 20 can be connected to the output port 18 of the device under test 12 via a cable-based or wireless connection that is configured to transmit signals between the respective devices or components.

The signal input 20 is configured to receive the digital input signal output by the device under test 12. It is noted that further electronic components may be interconnected between the device under test 12 and the signal input 20 in an embodiment. However, without restriction of generality it is assumed in the following that the device under test 12 is directly connected with the signal input 20.

The digital input signal received via the signal input 20 of the measurement instrument 14 is forwarded to the measurement circuit 22 and to the analysis circuit 24 for further processing, as will be described in more detail below.

FIG. 2 shows another embodiment of the measurement system 10, wherein only the differences compared to the embodiment of FIG. 1 described above are explained hereinafter. In contrast to the embodiment of FIG. 1 described above, the vector signal generator 26 is not integrated into the measurement instrument 14, but is rather established separately from the measurement instrument 14.

In an embodiment, the measurement instrument 14 may comprise a further signal input 30 that is connected to the vector signal generator 26 in a signal transmitting manner. The test signal generated by the vector signal generator 26 may be forwarded to the measurement circuit 22 via the further signal input 30. It is noted that a plurality of further measurement setups are possible with the measurement system 10 described above.

While the setups illustrated in FIGS. 1 and 2 are associated with measurements of forward transmission parameters of the device under test 12, the setups can readily be adapted for backward transmission measurements, input reflection measurements and/or output reflection measurements.

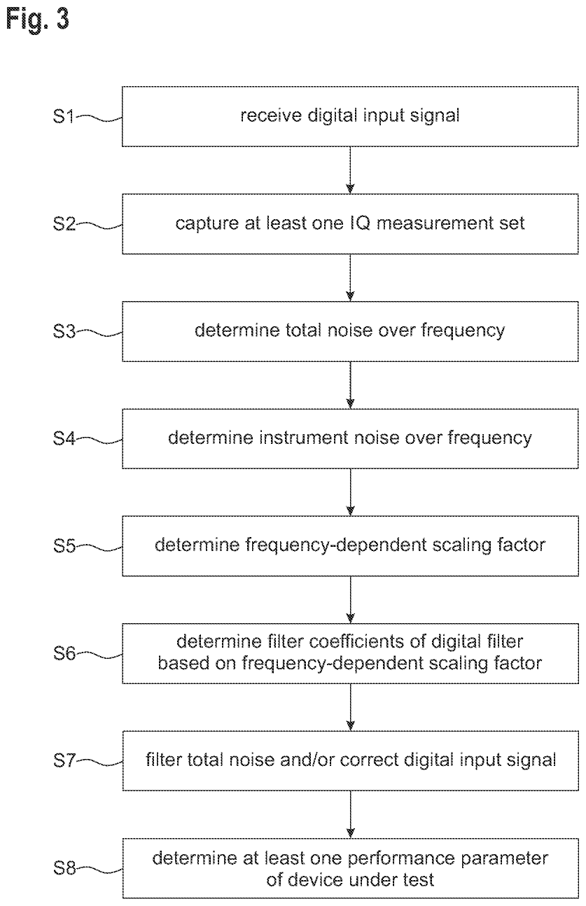

Irrespective of the particular embodiment, the measurement system 10 is configured to perform a signal processing method, an example of which is described hereinafter with reference to FIG. 3.

The digital input signal generated by the device under test 12 is received by the signal input 20 and is forwarded to the measurement circuit 22 (step S1).

As already mentioned above, the digital input signal may be received directly from the output port 18 of the device under test 12. Alternatively, the digital input signal may be received from another electronic component in the signal chain that is interconnected between the device under test 12 and the signal input 20.

Without restriction of generality, a certain exemplary case is described in the following, wherein the digital input signal is an IQ signal comprising IQ data. Thus, the digital input signal comprises in-phase data (I data) and quadrature data (Q data), such that the digital input signal comprises amplitude information and phase information.

At least one IQ measurement set is captured by the measurement circuit 22, wherein the at least one IQ measurement set comprises a plurality of IQ measurement points (step S2).

In an embodiment, a plurality of IQ measurement sets may be captured, wherein each IQ measurement set comprises a plurality of IQ measurement points. In other words, the captured IQ measurement sets comprise a plurality of IQ measurement samples, respectively.

Hereinafter, it is assumed without restriction of generality that a first number N₁ of IQ measurement sets associated with the received digital signal are captured by the measurement circuit 22.

In general, the IQ measurement sets and the individual IQ measurement points comprise a wanted signal portion (also called useful signal portion) of the digital input signal as well as noise, wherein the noise may originate in the device under test 12, in the measurement instrument 14, for example in the measurement circuit 22 and/or in the vector signal generator 26, and in any electronic components interconnected between the device under test 12 and the measurement instrument 14.

Accordingly, the measured signals (i.e. the IQ measurement sets) are given by the following equation:

$${s}_{meas} = G \cdot {s}_{ref} + {n}_{other} + {n}_{VSA} ( + G \cdot {n}_{VSG} )$$

Therein, sₘₑₐₛ is the measured signal, s_{ref} is an ideal reference signal, i.e. an ideal signal generated by the signal generator 26 that is processed by the device under test 12, n_{VSA} is noise generated by a signal analysis path of the measurement instrument 14 (i.e. by the measurement circuit 22), n_{VSG} is noise generated by a signal generator path of the measurement system 10 (i.e. by the vector signal generator 26), and G is a gain factor.

A total noise of the digital input signal over frequency is determined by the analysis circuit 24 based on the at least one IQ measurement set (step S3).

In general, the total noise may be determined by performing an IQ average over several IQ measurement sets, thereby obtaining an averaged signal. This way, noise cancels irrespective of its origin. The total noise may then be determined by subtracting the averaged signal from the at least one IQ measurement set.

One certain example for determining the total noise is described hereinafter. However, it is to be understood that any other suitable technique may be used in order to determine the total noise. In this example, the determined IQ average corresponds to an IQ average over (N₁−1) of the captured IQ measurement sets.

In an embodiment, for each of the N₁ IQ measurement sets s_{meas,i}, a respective IQ average s_{avg,i} may be determined that corresponds to an average over the other (N₁-1) IQ measurement sets s_{meas,j}, i.e.

$${s}_{avg , i} = \frac{1}{{N}_{1} - 1} {\sum }_{j = 1 , j \neq i}^{{N}_{1}} {s}_{meas , j} .$$

Therein, s_{meas,i} may describe the i-th IQ measurement set in frequency domain. The average may be performed over the IQ measurement points belonging to the same frequency bin, i.e. to the same frequency sub-band.

Accordingly, for each of a plurality of frequency bins covering the relevant frequency spectrum, an average over the plurality of IQ measurement sets may be performed.

As will be described in more detail below, not all of the IQ averages have to be calculated explicitly. Instead, it is sufficient to determine an IQ average over all N₁ IQ measurement sets, and to multiply the result by a certain factor.

A second number N₂ of noise vectors is determined based on the averaged signal and based on the captured IQ measurement sets. In an embodiment, a corresponding noise vector may be determined for each of the IQ measurement sets, i.e. the number N₂ may be equal to the number N₁. Without restriction of generality, N₁=N₂=N is assumed in the following.

The i-th total noise vector nᵢ(fₘ) for frequency bin fₘ is then given by

$${n}_{i} ( {f}_{m} ) = {s}_{meas , i} ( {f}_{m} ) - {s}_{avg} ( {f}_{m} ) .$$

Therein, s_{avg} is chosen to be the IQ average over all IQ measurement sets s_{meas,j} except for the IQ measurement point with index “i” in order to ensure that nᵢ is a valid noise vector.

The difference between the i-th IQ measurement set and the average signal s_{avg} can be rewritten as follows:

$$\begin{matrix}{s}_{meas , i} - {s}_{avg , N - 1} = {s}_{meas , i} - \frac{1}{N - 1} {\sum }_{j = 1 , j \neq i}^{N} {s}_{meas , j} \\ = {s}_{meas , i} - \frac{1}{N - 1} ( {\sum }_{j = 1}^{N} {s}_{meas , j} - {s}_{meas , i} ) \\ = {s}_{meas , i} + \frac{1}{N - 1} {s}_{meas , i} - \frac{1}{N - 1} {\sum }_{j = 1}^{N} {s}_{meas , j} \\ = {s}_{meas , i} ( 1 + \frac{1}{N - 1} ) - \frac{1}{N - 1} {\sum }_{j = 1}^{N} {s}_{meas , j}\end{matrix}$$

The average over the other (N−1) IQ measurement sets can be rewritten in terms of the average s_{avg,N} over all IQ measurement sets, thereby obtaining:

$$\begin{matrix}{s}_{meas , i} - {s}_{avg , N - 1} = {s}_{meas , i} ( 1 + \frac{1}{N - 1} ) - \frac{N}{N - 1} \cdot \frac{1}{N} {\sum }_{j = 1}^{N} {s}_{meas , j} \\ = {s}_{meas , i} ( 1 + \frac{1}{N - 1} ) - \frac{N}{N - 1} {s}_{avg , N}\end{matrix}$$

Thus, the final result for the noise vectors nᵢ is

$${n}_{i} ( {f}_{m} ) = \frac{N}{N - 1} ( {s}_{meas , i} ( {f}_{m} ) - {s}_{avg} ( {f}_{m} ) )$$

Accordingly, only a single IQ average s_{avg,N} has to be determined that can be used for determining all noise vectors.

The total noise nₜₒₜₐₗ may then be determined by averaging over the noise vectors nᵢ(fₘ) for each frequency bin fₘ separately, i.e.

$${n}_{total} ( {f}_{m} ) = \frac{1}{N} {\sum }_{j = 1}^{N} {n}_{i} ( {f}_{m} ) .$$

An instrument noise over frequency is determined by the analysis circuit 24, wherein the instrument noise corresponds to noise generated by the measurement instrument 14 (step S4).

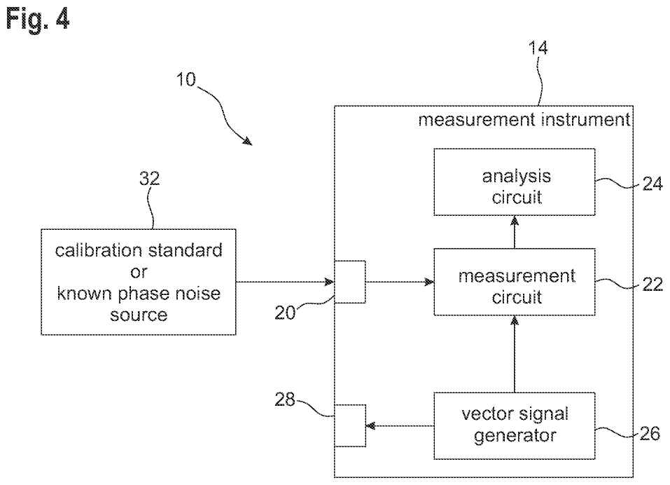

As is illustrated in FIG. 4, the instrument noise may be determined by connecting at least one calibration standard 32 to the signal input 20, and by performing a corresponding calibration measurement. For example, the at least one calibration standard 32 may be a “matched” calibration standard, i.e. a matched load that can be connected to the signal input.

A ratio of the instrument noise over frequency nᵢₙₛₜᵣ(fₘ) and the total noise over frequency nₜₒₜₐₗ (fₘ) is determined by the analysis circuit 24, thereby obtaining a frequency-dependent scaling factor w(fₘ) (step S5).

Accordingly, the frequency-dependent scaling factor w(fₘ) is given by

$$w ( {f}_{m} ) = \frac{{n}_{instr} ( {f}_{m} )}{{n}_{total} ( {f}_{m} )} .$$

Filter coefficients of a digital filter are determined by the analysis circuit 24 based on the frequency-dependent scaling factor (step S6).

In an embodiment, the frequency-dependent scaling factor w(fₘ) may be transformed into time domain, thereby obtaining filter coefficients W(tₙ). For example, a fast Fourier transform (FFT) of the frequency-dependent scaling factor w(fₘ) may be determined by the analysis circuit 24, thereby obtaining the filter coefficients W(tₙ), i.e. W(tₙ)=FFT[w(fₘ)].

In an embodiment, the digital filter may be integrated into the analysis circuit 24.

The total noise is filtered by the digital filter, thereby obtaining a filtered noise, and/or the digital input signal is corrected based on the filtered noise, thereby obtaining a noise-corrected input signal (step S7).

The filtered noise corresponds to the total noise corrected for the instrument noise. Thus, the filtered noise only comprises noise originating outside of the measurement instrument 14, for example only noise generated by the device under test 12. In the filtered noise, the instrument noise is removed on a frequency-selective basis.

The noise-corrected input signal corresponds to a useful signal (also called “wanted signal”) generated by the device under test 12 plus noise originating outside of the measurement instrument 14, for example the noise originating in the device under test 12. The noise-corrected input signal may be obtained by subtracting the total noise from the digital input signal, and by adding the filtered noise.

At least one performance parameter of the device under test 12 is determined based on the filtered noise and/or based on the noise-corrected input signal (step S8).

In an embodiment, the at least one performance parameter may be determined by a measurement application that is integrated into the analysis circuit 24. In general, the at least one performance parameter is indicative of a signal quality of the digital input signal and thus of a performance of the device under test 12. The at least one performance parameter may comprise an error vector magnitude (EVM). However, it is to be understood that the at least one performance parameter may comprise any other suitable signal parameter that is indicative of the signal quality of the digital input signal.

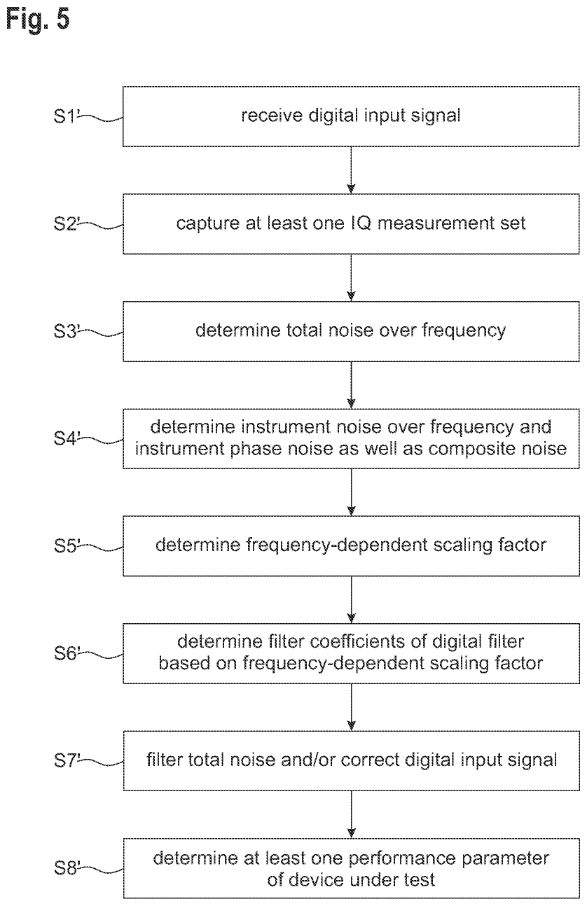

FIG. 5 shows a flow chart of another example of a signal processing method. Hereinafter, the differences compared to the signal processing method described above will be explained.

Steps S1′ to S3′ are performed analogously to steps S1 to S3 described above. In step S4′, an instrument phase noise is determined in addition to the instrument noise over frequency, namely instrument phase noise over frequency.

As is illustrated in FIG. 4, the instrument phase noise may be determined by connecting a known phase noise source 32 to the signal input 20, and by performing a corresponding calibration measurement. Alternatively, the instrument phase noise may be estimated based on a phase noise model, wherein the phase noise model describes the phase noise generated by the measurement instrument 14.

The phase noise n_{instr,ph}(fₘ) is added to the instrument noise nᵢₙₛₜᵣ(fₘ), thereby obtaining a composite noise n_{comp}(fₘ)=nᵢₙₛₜᵣ(fₘ)+n_{instr,ph}(fₘ), namely composite noise over frequency.

In step S5′, the frequency-dependent scaling factor w(fₘ) is determined as a ratio of the composite noise and the total noise, i.e.

$$w ( {f}_{m} ) = \frac{{n}_{comp} ( {f}_{m} )}{{n}_{total} ( {f}_{m} )} .$$

Steps S6′ to S8′ are performed analogously to steps S6 to S8 described above.

Certain embodiments disclosed herein include systems, apparatus, modules, units, devices, components, etc., that utilize circuitry (e.g., one or more circuits) in order to implement standards, protocols, methodologies or technologies disclosed herein, operably couple two or more components, generate information, process information, analyze information, generate signals, encode/decode signals, convert signals, transmit and/or receive signals, control other devices, etc. Circuitry of any type can be used. It will be appreciated that the term “information” can be use synonymously with the term “signals” in this paragraph. It will be further appreciated that the terms “circuitry,” “circuit,” “one or more circuits,” etc., can be used synonymously herein.

In an embodiment, circuitry includes, among other things, one or more computing devices such as a processor (e.g., a microprocessor), a central processing unit (CPU), a digital signal processor (DSP), an application-specific integrated circuit (ASIC), a field programmable gate array (FPGA), a system on a chip (SoC), or the like, or any combinations thereof, and can include discrete digital or analog circuit elements or electronics, or combinations thereof. In an embodiment, circuitry includes hardware circuit implementations (e.g., implementations in analog circuitry, implementations in digital circuitry, and the like, and combinations thereof).

In an embodiment, circuitry includes combinations of circuits and computer program products having software or firmware instructions stored on one or more computer readable memories that work together to cause a device to perform one or more protocols, methodologies or technologies described herein. In an embodiment, circuitry includes circuits, such as, for example, microprocessors or portions of microprocessor, that require software, firmware, and the like for operation. In an embodiment, circuitry includes an implementation comprising one or more processors or portions thereof and accompanying software, firmware, hardware, and the like.

For example, the functionality described herein can be implemented by special purpose hardware-based computer systems or circuits, etc., or combinations of special purpose hardware and computer instructions. Each of these special purpose hardware-based computer systems or circuits, etc., or combinations of special purpose hardware circuits and computer instructions form specifically configured circuits, machines, apparatus, devices, etc., capable of implementing the functionality described herein.

Of course, in an embodiment, two or more of these components, or parts thereof, can be integrated or share hardware and/or software, circuitry, etc. In an embodiment, these components, or parts thereof, may be grouped in a single location or distributed over a wide area. In circumstances where the components are distributed, the components are accessible to each other via communication links.

In an embodiments, one or more of the components, such as the measurement instrument 14, the DUT 12, the external vector signal generator 26 (FIG. 2), etc., referenced above include circuitry programmed to carry out one or more steps of any of the methods disclosed herein. In an embodiments, one or more computer-readable media associated with or accessible by such circuitry contains computer readable instructions embodied thereon that, when executed by such circuitry, cause the component or circuitry to perform one or more steps of any of the methods disclosed herein.

In an embodiment, the computer readable instructions includes applications, programs, program modules, scripts, source code, program code, object code, byte code, compiled code, interpreted code, machine code, executable instructions, and/or the like (also referred to herein as executable instructions, instructions for execution, program code, computer program instructions, and/or similar terms used herein interchangeably).

In an embodiment, computer-readable media is any medium that stores computer readable instructions, or other information non-transitorily and is directly or indirectly accessible to a computing device, such as processor circuitry, etc., or other circuitry disclosed herein etc. In other words, a computer-readable medium is a non-transitory memory at which one or more computing devices can access instructions, codes, data, or other information. As a non-limiting example, a computer-readable medium may include a volatile random access memory (RAM), a persistent data store such as a hard disk drive or a solid-state drive, or a combination thereof. In an embodiment, memory can be integrated with a processor, separate from a processor, or external to a computing system.

Accordingly, blocks of the block diagrams and/or flowchart illustrations support various combinations for performing the specified functions, combinations of operations for performing the specified functions and program instructions for performing the specified functions. These computer program instructions may be loaded onto one or more computer or computing devices, such as special purpose computer(s) or computing device(s) or other programmable data processing apparatus(es) to produce a specifically-configured machine, such that the instructions which execute on one or more computer or computing devices or other programmable data processing apparatus implement the functions specified in the flowchart block or blocks and/or carry out the methods described herein. Again, it should also be understood that each block of the block diagrams and flowchart illustrations, and combinations of blocks in the block diagrams and/or flowchart illustrations, or portions thereof, could be implemented by special purpose hardware-based computer systems or circuits, etc., that perform the specified functions or operations, or combinations of special purpose hardware and computer instructions.

In the foregoing description, specific details are set forth to provide a thorough understanding of representative embodiments of the present disclosure. It will be apparent to one skilled in the art, however, that the embodiments disclosed herein may be practiced without embodying all of the specific details. In some instances, well-known process steps have not been described in detail in order not to unnecessarily obscure various aspects of the present disclosure.

Although the method and various embodiments thereof have been described as performing sequential steps, the claimed subject matter is not intended to be so limited. As nonlimiting examples, the described steps need not be performed in the described sequence and/or not all steps are required to perform the method. Moreover, embodiments are contemplated in which various steps are performed in parallel, in series, and/or a combination thereof. As such, one of ordinary skill will appreciate that such examples are within the scope of the claimed embodiments.

In the detailed description herein, references to “one embodiment”, “an embodiment”, “an example embodiment”, etc., indicate that the embodiment described may include a particular feature, structure, or characteristic, but every embodiment may not necessarily include the particular feature, structure, or characteristic. Moreover, such phrases are not necessarily referring to the same embodiment. In addition, when a particular feature, structure, or characteristic is described in connection with an embodiment, it is submitted that it is within the knowledge of one skilled in the art to affect such feature, structure, or characteristic in connection with other embodiments whether or not explicitly described. After reading the description, it will be apparent to one skilled in the relevant art(s) how to implement the disclosure in alternative embodiments. Thus, it will be appreciated that embodiments of the present disclosure may employ any combination of features described herein. All such combinations or sub-combinations of features are within the scope of the present disclosure.

Throughout this specification, terms of art may be used. These terms are to take on their ordinary meaning in the art from which they come, unless specifically defined herein or the context of their use would clearly suggest otherwise.

The drawings in the FIGURES are not to scale. Similar elements are generally denoted by similar references in the FIGURES. For the purposes of this disclosure, the same or similar elements may bear the same references. Furthermore, the presence of reference numbers or letters in the drawings cannot be considered limiting, even when such numbers or letters are indicated in the claims.

The present application may reference quantities and numbers. Unless specifically stated, such quantities and numbers are not to be considered restrictive, but exemplary of the possible quantities or numbers associated with the present application. Also in this regard, the present application may use the term “plurality” to reference a quantity or number. In this regard, the term “plurality” is meant to be any number that is more than one, for example, two, three, four, five, etc. The terms “about,” “approximately,” “near,” etc., mean plus or minus 5% of the stated value. For the purposes of the present disclosure, the phrase “at least one of A and B” is equivalent to “A and/or B” or vice versa, namely “A” alone, “B” alone or “A and B.”. Similarly, the phrase “at least one of A, B, and C,” for example, means (A), (B), (C), (A and B), (A and C), (B and C), or (A, B, and C), including all further possible permutations when greater than three elements are listed.

The principles, representative embodiments, and modes of operation of the present disclosure have been described in the foregoing description. However, aspects of the present disclosure which are intended to be protected are not to be construed as limited to the particular embodiments disclosed. Further, the embodiments described herein are to be regarded as illustrative rather than restrictive. It will be appreciated that variations and changes may be made by others, and equivalents employed, without departing from the spirit of the present disclosure. Accordingly, it is expressly intended that all such variations, changes, and equivalents fall within the spirit and scope of the present disclosure, as claimed.

1. A signal processing method of processing a digital input signal by a measurement instrument, the measurement instrument comprising a signal input, a measurement circuit, and an analysis circuit, the signal processing method comprising:
receiving, by the signal input, a digital input signal from a device under test;
capturing, by the measurement circuit, at least one IQ measurement set based on the received input signal, wherein the at least one IQ measurement set comprises a plurality of IQ measurement points;
determining, by the analysis circuit, a total noise of the digital input signal over frequency based on the at least one IQ measurement set;
determining, by the analysis circuit, an instrument noise over frequency, wherein the instrument noise corresponds to noise generated by the measurement instrument; and
determining, by the analysis circuit, a ratio of the instrument noise and the total noise over frequency, thereby obtaining a frequency-dependent scaling factor.

2. The signal processing method of claim 1, wherein filter coefficients of a digital filter are determined by the analysis circuit based on the frequency-dependent scaling factor.

3. The signal processing method of claim 2, wherein the frequency-dependent scaling factor is transformed into time-domain, thereby obtaining the filter coefficients.

4. The signal processing method of claim 2, wherein the total noise is filtered by the digital filter, thereby obtaining a filtered noise.

5. The signal processing method of claim 4, wherein at least one performance parameter is determined based on the filtered noise, wherein the at least one performance parameter is indicative of a signal quality of the digital input signal.

6. The signal processing method of claim 5, wherein the at least one performance parameter comprises an error vector magnitude (EVM).

7. The signal processing method of claim 4, wherein the digital input signal is corrected based on the filtered noise, thereby obtaining a noise-corrected input signal.

8. The signal processing method of claim 1, wherein the instrument noise is determined by connecting at least one at least one calibration standard to the signal input.

9. The signal processing method of claim 1, wherein a plurality of measurement sets are captured by the measurement circuit based on the received input signal, wherein each IQ measurement set comprises a plurality of IQ measurement points, wherein an IQ average is determined by the analysis circuit based on the captured IQ measurement sets, thereby obtaining an averaged signal, and wherein the total noise of the digital input signal over frequency is determined based on the averaged signal and based on the plurality of IQ measurement sets.

10. A signal processing method for processing a digital input signal by a measurement instrument, the measurement instrument comprising a signal input, a measurement circuit, and an analysis circuit, the signal processing method comprising:
receiving, by the signal input, a digital input signal from a device under test;
capturing, by the measurement circuit, at least one IQ measurement set based on the received input signal, wherein the at least one IQ measurement set comprises a plurality of IQ measurement points;
determining, by the analysis circuit, a total noise of the digital input signal over frequency based on the at least one IQ measurement set;
determining, by the analysis circuit, an instrument noise over frequency, wherein the instrument noise corresponds to noise generated by the measurement instrument;
determining, by the analysis circuit, an instrument phase noise, wherein the instrument phase noise corresponds to phase noise generated by the measurement instrument;
adding, by the analysis circuit, the instrument phase noise to the instrument noise, thereby obtaining composite noise; and
determining, by the analysis circuit, a ratio of the composite noise and the total noise over frequency, thereby obtaining a frequency-dependent scaling factor.

11. The signal processing method of claim 10, wherein filter coefficients of a digital filter are determined by the analysis circuit based on the frequency-dependent scaling factor.

12. The signal processing method of claim 11, wherein the frequency-dependent scaling factor is transformed into time-domain, thereby obtaining the filter coefficients.

13. The signal processing method of claim 11, wherein the total noise is filtered by the digital filter, thereby obtaining a filtered noise.

14. The signal processing method of claim 13, wherein at least one performance parameter is determined based on the filtered noise, wherein the at least one performance parameter is indicative of a signal quality of the digital input signal.

15. The signal processing method of claim 14, wherein the at least one performance parameter comprises an error vector magnitude (EVM).

16. The signal processing method of claim 13, wherein the digital input signal is corrected based on the filtered noise, thereby obtaining a noise-corrected input signal.

17. The signal processing method of claim 10, wherein the instrument phase noise is determined by connecting a known phase noise source to the signal input.

18. The signal processing method of claim 10, wherein the instrument phase noise is estimated based on a phase noise model, wherein the phase noise model describes the phase noise generated by the measurement instrument.

19. The signal processing method of claim 10, wherein a plurality of measurement sets are captured by the measurement circuit based on the received input signal, wherein each IQ measurement set comprises a plurality of IQ measurement points, wherein an IQ average is determined by the analysis circuit based on the captured IQ measurement sets, thereby obtaining an averaged signal, and wherein the total noise of the digital input signal over frequency is determined based on the averaged signal and based on the plurality of IQ measurement sets.

20. A measurement instrument, comprising:
a signal input configured to receive a digital input signal from a device under test;
a measurement circuit configured to capture at least one IQ measurement set based on the received input signal, wherein the at least one IQ measurement set comprises a plurality of IQ measurement points, and
an analysis circuit configured to:
determine a total noise of the digital input signal based on the at least one IQ measurement set;
determine an instrument noise over frequency or a composite noise, wherein the instrument noise corresponds to noise generated by the measurement instrument, and wherein the composite noise is a sum of the instrument noise and instrument phase noise, and
determine a ratio of the instrument noise and the total noise over frequency or a ratio of the composite noise and the total noise over frequency, thereby obtaining a frequency-dependent scaling factor.
